(19) United States
(12) Patent Application Publication
(10) Pub. No.: US 2010/0165940 A1
(43) Pub. Date: Jul. 1, 2010

(54) METHOD AND APPARATUS FOR TRACKING AREA UPDATE PROCEDURE AND EPS BEARER CONTEXTS REPRESENTATION

(75) Inventors: Mahmoud Watfa, Saint Leonard (CA); Peter S. Wang, East Setauket, NY (US); Behrouz Aghili, Commack, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/648,465

(22) Filed: Dec. 29, 2009

Related U.S. Application Data
(60) Provisional application No. 61/141,090, filed on Dec. 29, 2008.
(60) Provisional application No. 61/153,139, filed on Feb. 17, 2009.

(51) Int. Cl. H04W 4/02

(52) U.S. Cl. 370/329

(57) ABSTRACT

A method and an apparatus for a new use of the active flag bit in tracking area update (TAU) and a new optional or conditional information element (IE) included in the TAU request message is disclosed. A method and apparatus for only maintaining non-access stratum (NAS) signaling in addition to not establishing S1 bearer and radio bearer for all active evolved packet system (EPS) bearer context are also provided. Several new formats representing EPS bearer context identities and a new representation scheme are disclosed to uniquely identify EPS bearer contexts in EPS bearer context status IE.

### CROSS REFERENCE TO RELATED APPLICATION

This application claims the benefit of U.S. Provisional Application Ser. No. 61/141,090 filed on Dec. 29, 2008, and U.S. Provisional Application Ser. No. 61/153,139 filed on Feb. 17, 2009, both of which are hereby incorporated by reference as if fully set forth herein.

### FIELD OF INVENTION

This application is related to wireless communications.

### BACKGROUND

In wireless communications, a procedure used by protocols for mobility management and session management between a wireless transmit/receive unit (WTRU) and a mobility management entity (MME) is described having the protocols belong to a non-access stratum (NAS). One example of this is an evolved packet system (EPS) session management (ESM) protocol, which provides procedures for handling of bearer contexts. In both the session management and mobility management NAS protocols there is a support for inter-system mobility between evolved universal mobile telecommunications system (UMTS) terrestrial radio access network (E-UTRAN) and other third generation partnership project (3GPP) (i.e., global system for mobile communications (GSM) enhanced data rates for GSM evolution (EDGE) radio access network (GERAN) and UTRAN) or non-3GPP access networks.

Long term evolution (LTE) EPS, defined as part of the 3GPP work item called system architecture evolution (SAE), is an evolution of the 3GPP system architecture. The EPS includes E-UTRAN and evolved packet core (EPC). The E-UTRAN and the EPC may be optimized for the delivery of all services using internet protocol (IP), including voice service using voice over IP (VoIP).

In E-UTRAN, a model of an EPS bearer context refers to a user plane profile including a set of identities, an associated IP address, a quality of service (QoS) agreement, and a traffic flow template (TFT). Upon attachment to the network, a WTRU obtains a connection to a default packet data node (PDN) gateway, which activates a default EPS bearer context for the WTRU. Accordingly, the WTRU has an active EPS bearer context. The WTRU may also request dedicated EPS bearer contexts to be activated. Each context is identified by a unique identity (i.e., EPS bearer identity), and a dedicated EPS bearer context is linked to the default EPS bearer by a linked EPS bearer identity.

Additionally, the WTRU may request other PDN connections and dedicated EPS bearers from a new PDN. Accordingly, the WTRU may have several linked EPS bearer identities to which dedicated EPS bearers, identified by EPS bearer identities, are associated or linked.

An EPS bearer context maybe uniquely identified by its EPS bearer identity and linked EPS bearer identity. The linked EPS bearer identity may be four (4) bits long and the EPS bearer identity may also be four (4) bits long. The EPS bearer identity may be located in the bits five (5) to eight (8) (inclusive and hence total of 4 bits) of the first octet of every NAS ESM message. FIG. 1 is a representation of the linked EPS bearer identity. The linked EPS bearer identity value is located in the bits one (1) to four (4) of the first octet as seen in FIG. 1. The values of the linked EPS bearer identity are defined in Table 1.

TABLE 1
Linked EPS bearer identity (bits 1-4)

Bits

| 4 | 3 | 2 | 1 |
|---|---|---|---|
| 0 | 0 | 0 | 0 |

| | |
|---|---|
| to | Reserved |

| | | | | |
|---|---|---|---|---|
| 0 | 1 | 0 | 0 | |
| 0 | 1 | 0 | 1 | EPS bearer identity value 5 |
| 0 | 1 | 1 | 0 | EPS bearer identity value 6 |
| 0 | 1 | 1 | 1 | EPS bearer identity value 7 |
| 1 | 0 | 0 | 0 | EPS bearer identity value 8 |
| 1 | 0 | 0 | 1 | EPS bearer identity value 9 |
| 1 | 0 | 1 | 0 | EPS bearer identity value 10 |
| 1 | 0 | 1 | 1 | EPS bearer identity value 11 |
| 1 | 1 | 0 | 0 | EPS bearer identity value 12 |
| 1 | 1 | 0 | 1 | EPS bearer identity value 13 |
| 1 | 1 | 1 | 0 | EPS bearer identity value 14 |
| 1 | 1 | 1 | 1 | EPS bearer identity value 15 |

In an E-UTRAN, tracking area (TA) may be defined by a location similar to a routing area in GERAN/UTRAN. When a WTRU is in a radio resource control (RRC) CONNECTED state, the location of the WTRU is known at the cell level. When the WTRU is in an RRC_IDLE state, the location of the WTRU is known at a TA level. Accordingly, the WTRU informs or updates the network whenever it enters a new TA by sending a tracking area update (TAU) message. A TAU message may be normal, or periodic if the WTRU is in the RRC_IDLE state. The WTRU may indicate the type of TAU prepared by specifying different values for the EPS update type informational element (IE) that is included in the TAU message.

The current contents of a TAU message, are illustrated below in Table 2. The format is in the form of value only (V), type only (T), type and value (TV), length and value (LV), or type, length and value (TLV). The present requirement is indicated by mandatory (M) or optional (O). The length of the IE is represented in octets in the message.

TABLE 2

| | Information | | | For- | |
|---|---|---|---|---|---|
| IEI | Element (IE) | Type/Reference | Presence | mat | Length |
| | Protocol | Protocol | M | V | ½ |
| | discriminator | discriminator | | | |
| | Security header type | Security header | M | V | ½ |
| | | type | | | |
| | Tracking area | Message type | M | V | 1 |
| | update request | | | | |
| | message identity | | | | |
| | EPS update type | EPS update | M | V | ½ |
| | | type | | | |
| | Spare half octet | Spare half octet | M | V | ½ |
| | Old Globally | EPS mobile | M | LV | 12 |
| | Unique | identity | | | |
| | Temporary Identity | | | | |
| | (GUTI) | | | | |
| | NAS key set | NAS key set | M | V | ½ |
| | identifier_{ASME} | identifier | | | |
| | NAS key set | NAS key set | M | V | ½ |
| | identifier_{SGSN} | identifier | | | |
| 19 | Old Packet | P-TMSI | O | TV | 4 |
| | Temporary Mobile | signature | | | |
| | Subscriber Identity | | | | |
| | (P-TMSI) signature | | | | |
| 55 | Nonce_{UE} | Nonce | O | TV | 5 |
| 31 | MS network | MS network | O | TLV | 4-10 |
| | capability | capability | | | |
| 52 | Last visited | Tracking area | O | TV | 6 |
| | registered Tracking | identity | | | |
| | Area Identity (TAI) | | | | |
| 57 | EPS bearer context | EPS bearer | O | TLV | 4 |
| | status | context status | | | |
| 13 | Old location area | Location area | O | TV | 6 |
| | identification | identification | | | |
| 9- | TMSI status | TMSI status | O | TV | 1 |

The EPS update type IE specifies an area with which the updating procedure is associated. FIG. 2 illustrates a way of coding the EPS update type IE. Table 3 describes the EPS update type, which is a type 1 information element.

TABLE 3
EPS update type value (octet 1, bit 1 to 3)

| Bits | | | |
|---|---|---|---|
| 3 | 2 | 1 | |
| 0 | 0 | 0 | TA updating |
| 0 | 0 | 1 | Combined TA/location area (LA) updating |
| 0 | 1 | 0 | Combined TA/LA updating with international |
| | | | mobile station identity (IMSI) attach |
| 0 | 1 | 1 | Periodic updating |

All other values are reserved.

Active flag bit (octet 1, bit 4)

| Bit | |
|---|---|
| 4 | |
| 0 | No bearer establishment requested |
| 1 | Bearer establishment requested |

As illustrated above, the fourth bit of the EPS update type IE is called an active flag bit. If a WTRU in an EPS mobility management (EMM)-IDLE mode has an uplink (UL) user data pending when it initiates the TA updating procedure, or UL signaling not related to the TA updating procedure, the WTRU may also set the active flag bit in the TAU request message. The WTRU may set the active flag bit in order to indicate the request to establish the user plane to the network and to keep the NAS signaling connection after the completion of the TA updating procedure. If the active flag bit is included in the TAU request message, the MME may reestablish the radio bearer and S1 bearer for all of the active EPS bearer contexts. Thus, if the active flag bit is set equal to one (1), the MME keeps the NAS signaling active and also establishes radio and S1 bearers for all of the active EPS bearer contexts.

In E-UTRAN, an EPS bearer context status refers to an IE indicating the state of each EPS bearer context that may be identified by an EPS bearer identity (EBI). The EPS bearer context status IE is coded as shown in FIG. 3 and in Table 4. The EPS bearer context status information element is a type 4 information element with four (4) octets length.

TABLE 4
EBI(x) shall be coded as follows:

EBI(0)-EBI(4):
Bits 0 to 4 of octet 3 are spare and shall be coded as zero.
EBI(5)-EBI(15):
0 indicates that the ESM state of the corresponding EPS bearer context is
BEARER CONTEXT-INACTIVE.
1 indicates that the ESM state of the corresponding EPS bearer context is
BEARER CONTEXT-ACTIVE.

According to the current configuration, a WTRU requires the network to maintain the NAS signaling because the NAS messages are sent shortly after the TAU procedure. Accordingly, the network establishes the radio bearer and the S1 bearer for all active EPS bearer contexts, which leads to reserving network resources that are never used. For example, when the user attempts to send a short message service (SMS) message which is encapsulated in an NAS signaling message, there is no need to re-establish radio bearer and S1 bearers for all active EPS bearer contexts. A new EPS bearer context configuration is necessary to utilize saved network resources. It is desirable to define and configure new EPS bearer contexts, new TAU procedures, and new EPS bearer context statuses.

Another example with consequences is when a user initiates a circuit-switched (CS) call request which kicks-off a CS fallback (CSFB) mechanism via NAS signaling message. For this example, and according to the current specification, radio bearer and S1 bearer for all active EPS bearers may be established by the network, but the WTRU may ultimately fallback to a target radio access technology (RAT). When the WTRU sends the actual NAS message to indicate the CSFB request, it would appear as if the WTRU had an active packet-switched (PS) session in LTE.

According to the CSFB procedure, PS resources may be reserved in the target RAT in order to handover all of the bearer context that are active in E-UTRAN and for which bearers have been established, because of a value of the active flag bit, resulting in delays. The delays add to the process which should have otherwise been completed with less signaling and time.

Moreover, it is possible that the WTRU has UL user data for transmission to establish radio bearer and S1 bearer for a specific bearer context. Currently, the WTRU may not indicate the context for which it wishes to establish the bearers. Instead, the network may establish radio bearers for all active bearer contexts. This is not efficient in the context where a user wishes to interact with only one application corresponding to one bearer context. According to the current architecture, all of the active contexts are provided radio bearer and S1 bearer support without actually being used, thus valuable network resources are wasted.

Furthermore, there is no current IE that identifies an EPS bearer context as part of an EPS bearer identity. An EPS bearer identity is incorporated in the first octet of every ESM NAS message. The linked EPS bearer identity has a defined IE. Thus, the EPS bearer context identity is split in the ESM messages and there is currently no IE that includes both the linked EPS bearer identity and the EPS bearer identity

The current details of the EPS bearer context status IE do not uniquely define a bearer context in the case where there are connections to multiple PDN gateways. An EPS bearer context is uniquely identified by a linked EPS bearer context identity and an EPS bearer context identity. Thus, the current EPS bearer context status IE does not uniquely identify the EPS bearer contexts of the WTRU.

A need exists for an enhanced use of an active flag bit of a TAU request message to determine weather only NAS signaling is maintained. Moreover, a new informational element is desired to be included in a TAU message, and new ways to represent the EPS bearer contexts to be used in the context status IE are also desired.

### SUMMARY

A method and an apparatus for a use of the active flag bit in a TAU procedure and a new optional IE or a conditional IE included in the TAU request message is disclosed. Several new formats representing EPS bearer context identities and a new representation scheme are disclosed to uniquely identify EPS bearer contexts in EPS bearer context status IE.

An MME comprising a transceiver configured to receive a TAU request message including an EPS update type information element, a processor configured to verify a value of an active flag bit within the EPS update type information element, and on a condition that the value of the active flag bit is equal to one, the processor is further configured to only maintain NAS signaling is provided. On a condition that the value of the active flag bit is equal to one, the processor of the MME is further configured to maintain NAS signaling without establishing S1 bearer and radio bearer for all active EPS bearer context.

### BRIEF DESCRIPTION OF THE DRAWINGS

A more detailed understanding may be had from the following description, given by way of example in conjunction with the accompanying drawings wherein:

FIG. 1 shows a linked EPS bearer identity in accordance with the prior art;

FIG. 2 shows an EPS update type information element in accordance with the prior art;

FIG. 3 shows an EPS bearer context status information element in accordance with the prior art;

FIG. 4 shows an LTE wireless communication system/access network;

FIG. 5 illustrates an exemplary block diagram of the LTE wireless communication system/access network as shown in FIG. 4;

FIG. 6 shows tracking are update procedure according to one embodiment.

FIG. 7 shows tracking are update procedure according to another embodiment.

FIG. 8 shows the IE defined as chosen active EPS bearer contexts IE along with a coding format;

FIG. 9 shows a coding format of each identity of an active bearer context;

FIG. 10 shows a television format representing the EPS context identity according to one embodiment;

FIG. 11 shows an identity of an active bearer context;

FIG. 12 shows a television format representing the EPS context identity according to another embodiment;

FIGS. 13 and 14 illustrate a combined linked EPS bearer identity and a EPS bearer identity; and

FIGS. 15 and 16 separately specify linked EPS bearer identity and EPS bearer context identity.

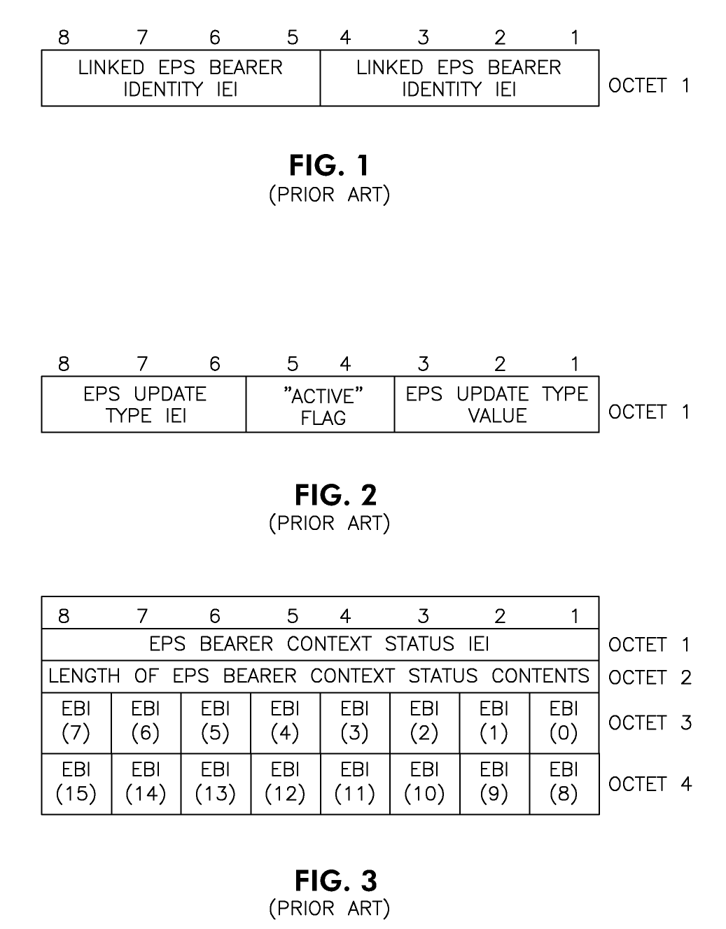

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

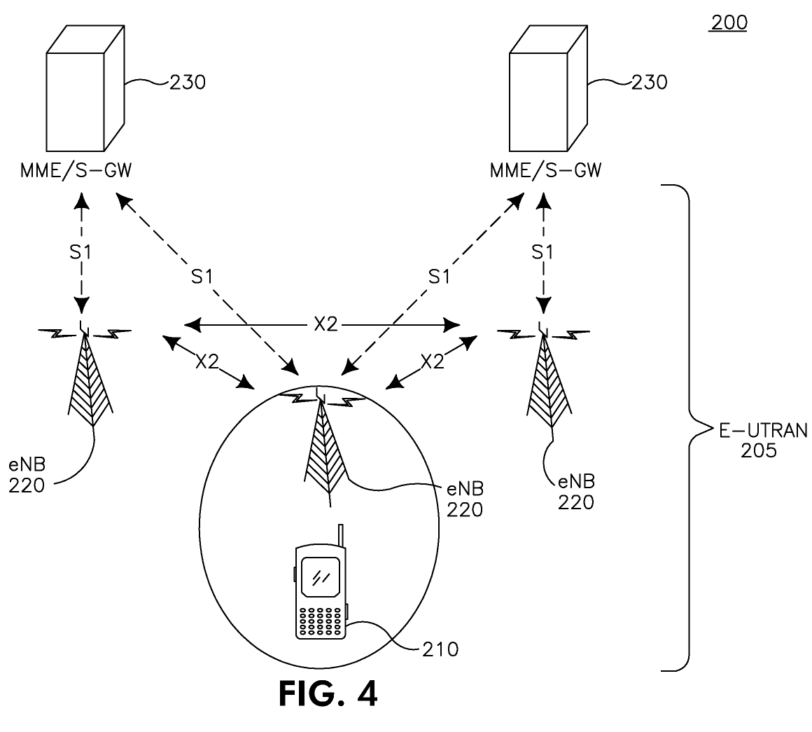

FIG. 4 shows an LTE wireless communication system/access network 200 that includes an E-UTRAN 205. The E-UTRAN 205 includes a WTRU 210 and several evolved Node-Bs, (eNBs) 220. The WTRU 210 is in communication with an eNB 220. The eNBs 220 interface with each other using an X2 interface. Each of the eNBs 220 interface with an MME/Serving GateWay (S-GW) 230 through an S1 interface. Although a single WTRU 210 and three eNBs 220 are shown in FIG. 4, it should be apparent that any combination of wireless and wired devices may be included in the wireless communication system/access network 200.

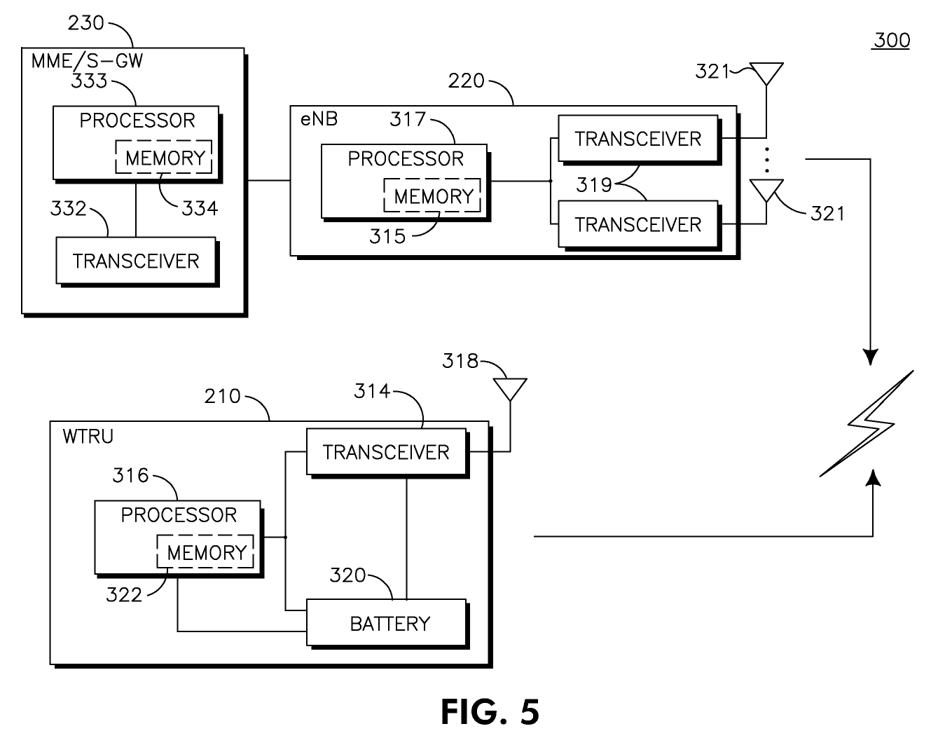

FIG. 5 is an exemplary block diagram of an LTE wireless communication system/access network 300 including the WTRU 210, the eNB 220, and the MME/S-GW 230. As shown in FIG. 5, the WTRU 210, the eNB 220 and the MME/S-GW 230 are configured to perform a method for TAU procedure and EPS bearer contexts representation.

In addition to the components that may be found in a typical WTRU, the WTRU 210 includes a processor 316 with an optional linked memory 322, at least one transceiver 314, an optional battery 320, and an antenna 318. The processor 316 is configured to perform a method for TAU procedure and EPS bearer contexts representation. The transceiver 314 is in communication with the processor 316 and the antenna 318 to facilitate the transmission and reception of wireless communications. In case a battery 320 is used in the WTRU 210, it powers the transceiver 314 and the processor 316.

In addition to the components that may be found in a typical eNB, the eNB 220 includes a processor 317 with an optional linked memory 315, transceivers 319, and antennas 321. The processor 317 is configured to perform a method for TAU procedure and EPS bearer contexts representation. The transceivers 319 are in communication with the processor 317 and antennas 321 to facilitate the transmission and reception of wireless communications. The eNB 220 is connected to the MME/S-GW 230 which includes a transceiver 332 and a processor 333 with an optional linked memory 334.

In a first embodiment, a new interpretation for the active flag bit is described. If the active flag bit is set by the WTRU 210, the NAS signaling is maintained by the network after performing the TAU procedure. The network may maintain the NAS signaling on a condition that the active flag bit is set equal to one (1) and no radio bearer or S1 bearer are to be established. Otherwise, if the value of the active flag bit is equal to zero (0), then the network may not maintain any NAS signaling after the TAU procedure is completed. The possibilities for interpretation of the active flag bit are as shown in Table 5.

TABLE 5
Active flag bit (octet 1, bit 4)

| Bit | |
|---|---|
| 4 | |
| 0 | No NAS signaling shall be maintained |
| 1 | Maintain NAS signaling only |

If a WTRU 210 desires to establish lower layer support for a specific bearer context, the WTRU may use other NAS messages to do so since the NAS signaling is maintained. Alternatively, to indicate maintenance of NAS signaling for other signaling messages to be sent by the WTRU, code points are defined for the EPS update type IE. The code points, shown in Table 6, are in addition to setting the active flag bit equal to one (1).

Alternatively, one of the values may be used to indicate to the network that the signaling connection is to be maintained and that the radio bearer and S1 bearer for all active EPS bearer contexts may also be established. This is in addition to setting the active flag bit equal to one (1).

TABLE 6
EPS update type value (octet 1, bit 1 to 3)

| Bits | | | |
|---|---|---|---|
| 3 | 2 | 1 | |
| 0 | 0 | 0 | TA updating |
| 0 | 0 | 1 | Combined TA/LA updating |
| 0 | 1 | 0 | Combined TA/LA updating with IMSI attach |
| 0 | 1 | 1 | Periodic updating |
| 1 | 0 | 0 | TA updating and maintain NAS signaling for other |
| | | | follow-up NAS signaling messages |
| 1 | 0 | 1 | Combined TA/LA updating and maintain NAS signaling for |
| | | | other follow-up NAS signaling messages |
| 1 | 1 | 0 | Combined TA/LA updating with IMSI attach and maintain |
| | | | NAS signaling for other follow-up NAS signaling messages |
| 1 | 1 | 1 | Periodic updating and maintain NAS signaling for other |
| | | | follow-up NAS signaling messages |

All other values are reserved.

Active flag bit (octet 1, bit 4)

| Bit | |
|---|---|
| 4 | |
| 0 | No NAS signaling shall be maintained |
| 1 | Maintain NAS signaling (and interpret code point accordingly) |

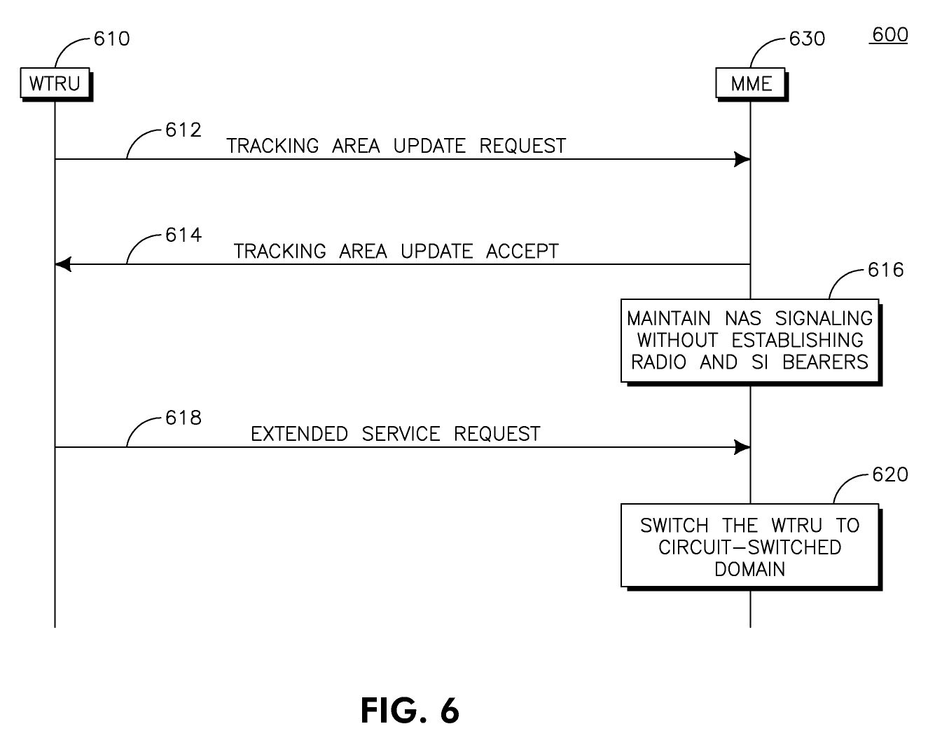

FIG. 6 shows tracking area update procedure 600 according to one embodiment. The WTRU 610 is configured to transmit a TAU request message 612 to the MME 630. The TAU request message 612 includes the active flag bit that is set equal to one (1) and the EPS update type value (as defined in Table 6) is set equal to 111. The EPS update type value represents bits one (1) to three (3) of octet one. The MME 630 is configured to send TAU accept message 614 to WTRU 610. The MME 630 is configured to not establish radio and S1 bearers 615. The MME 630 is configured to maintain NAS signaling 616 on a condition that a value of the active flag bit is one (1) and on a condition that no radio and S1 bearers are to be established. The WTRU 610 is configured to transmit an extended service request to the MME 630. The extended service request may be the required NAS message for CSFB. The MME 630 is configured to move the WTRU 610 to CS domain using the known CSFB procedures 620. The EPS update type value may be one of the values described in Table 6. Alternatively, on a condition that the value of the active flag bit is set to zero (0), then the network may not maintain any NAS signaling after the TAU procedure completes.

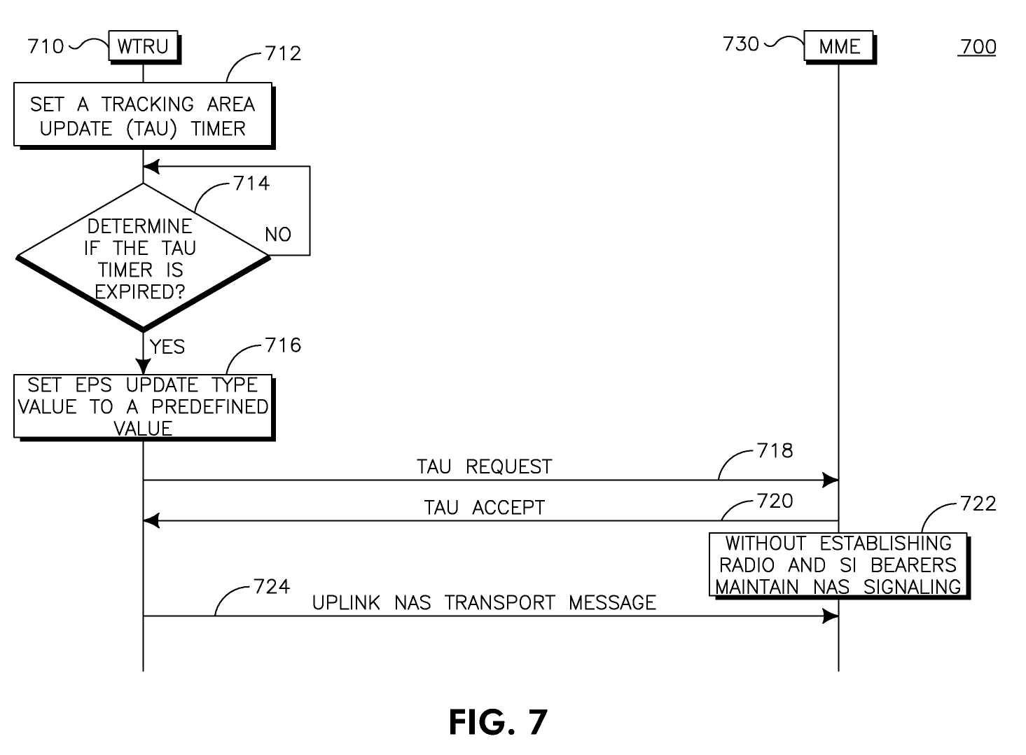

FIG. 7 shows tracking area update procedure 700 according to another embodiment. The WTRU 710 is configured to set a TAU timer 712. The WTRU 710 is configured to determine whether the TAU timer 712 has expired 714. On a condition that the TAU timer has expired 714, the WTRU 710 is configured to set the EPS update type value to a predefined value 714. On a condition that the TAU timer has not expired 714, the WTRU 710 is configured to check whether the TAU timer has expired. The WTRU 710 is configured to transmit a TAU request message 718 to the MME 730. The TAU request message 718 includes the active flag bit that is set equal to one (1) and the EPS update type value (as predefined in Table 6). The EPS update type value represents bits one (1) to three (3) of octet one. The MME 730 is configured to send TAU accept message 720 to WTRU 710. The MME 730 is configured to not establish radio and S1 bearers 722. The MME 730 is configured to maintain NAS signaling 722 on a condition that a value of the active flag bit is one (1) and on a condition that no radio and S1 bearers are to be established. The WTRU 710 is configured to transmit an uplink NAS transport message 724. Alternatively, on a condition that the value of the active flag bit is set to zero (0), then the network may not maintain any NAS signaling after the TAU procedure completes.

A method for a new IE used to identify the active bearer contexts for which the network may establish radio bearer and S1 bearer if the active flag bit is set equal to one (1) is disclosed. An IE is defined that may be used to indicate the active bearer context for which the network may establish radio bearer and S1 bearer on a condition that the WTRU 210 has an UL data to transmit and the active flag bit is set equal to one (1). Thus, when an MME 230 is configured to receive the TAU request message, the MME 230 may be configured to verify the value of the active flag bit. If the active flag bit is set equal to one (1), the MME 230 may be configured to check whether an optional IE or a conditional IE is included in the TAU message. If either the optional IE or the conditional IE is included in the TAU message, the MME 230 may be configured to activate the radio bearer and S1 bearer for the active bearer contexts that are identified in the new IE. Alternatively, if the active flag bit has a value of zero (0), the WTRU 210 may not include the IE in the TAU message.

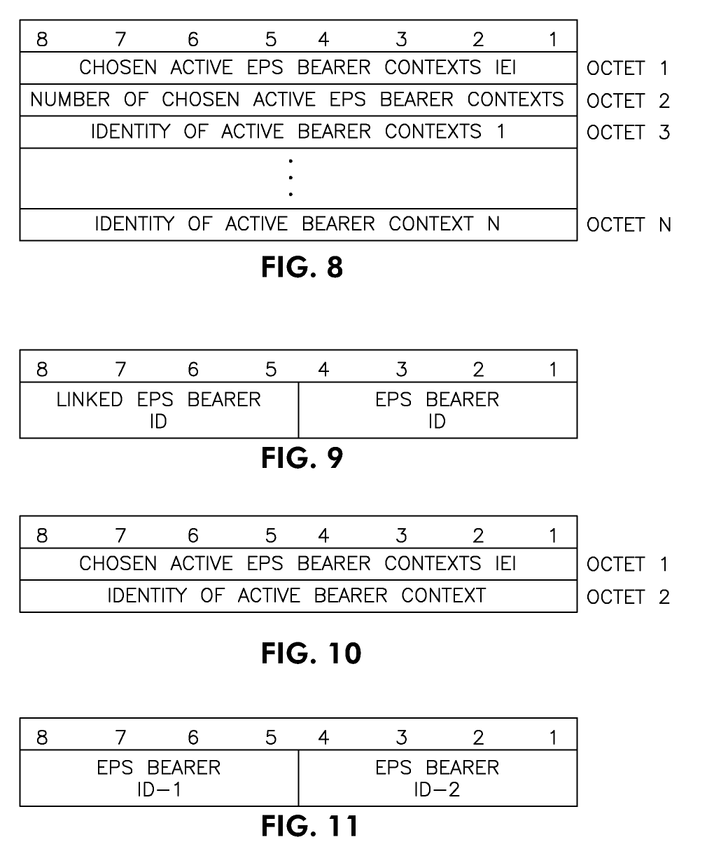

FIG. 8 shows the IE defined as chosen active EPS bearer contexts IE identifier (JET) (i.e., octet 1) and also shows the IE coding. The octet 2, which is the number of chosen active EPS bearer contexts, holds a number N of active bearer context requiring establishment of radio and S1 bearers, where N is an integer. The identities of active bearer context, which starts from octet three (3) and is the same for the N-1 octets that follows the third octet, are defined in FIG. 9. The illustration of FIG. 8 may be used if the WTRU 210 has more than one PDN connection, and the activation desires to specify EPS bearer contexts on different PDN connections.

A new value may be required for the chosen active EPS bearer contexts IE. A number of chosen active EPS bearer contexts in octet 2 of FIG. 8 indicate the number of active bearer contexts the WTRU 210 requires to establish a radio bearer and an S1 bearer. A number of chosen active EPS bearer contexts also indicate the number of active bearer context identities that follow in octet 3.

Each identity of an active bearer context seen in octet 3, for example, in FIG. 8 is eight (8) bits long and the coding is shown in FIG. 9. Bits five (5) to eight (8) of FIG. 9 indicate the linked EPS bearer identity, while bits one (1) to four (4) indicate the identity of the EPS bearer. The actual coding may be vice versa, that is, bits five (5) to eight (8) may indicate the EPS bearer identity and bits one (1) to four (4) may indicate the linked EPS bearer identity. The linked EPS bearer identity and EPS bearer identity are as defined in Table 1.

Alternatively, the TV format (i.e., no length indicator field) may be used to represent the EPS context identity as shown in FIG. 10. This format does not have a length indicator as seen in FIG. 8 as octet 2. Therefore, there may be only one octet for the identity of EPS bearer contexts which may be used to identify only two (2) EPS bearer contexts. The octet 2 showing the identity of active bearer context in FIG. 10 holds the identity of at most two (2) EPS bearer contexts when the WTRU 210 has one PDN connection. Bits five (5) to eight (8) hold the identity of the first context and bits one (1) to four (4) hold the identity of the second context. Each of these identities are represented as shown in Table 1.

The chosen JET, a different value than the JET above, may represent a case in which the WTRU 210 has one PDN connection; therefore, the linked EPS context may be derived from the WTRU 210 context in MME 230 and no signaling is required. FIG. 11 shows that the one octet space may hold two EPS bearer context IDs, which is sufficient for the reestablishment. FIG. 11 shows the identity of active bearer context as EPS bearer ID—1 (bits five (5) to eight (8) and EPS bearer ID—2 (bits one (1) to four (4)).

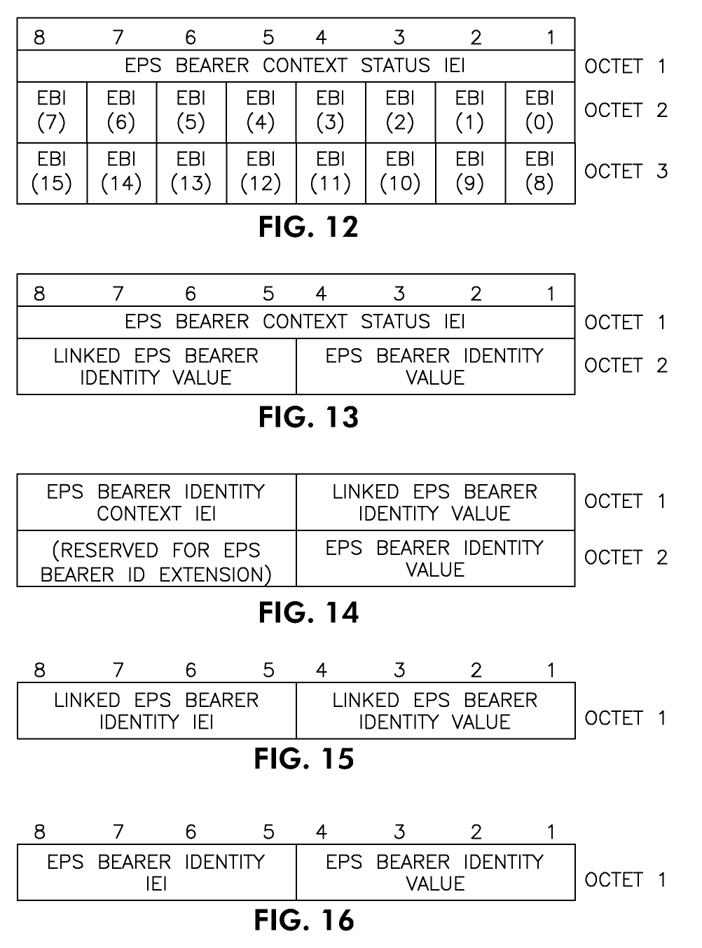

If only one EPS bearer context is specified, the bits one (1) to (4) for ID—2 as seen in FIG. 11 may all be set equal to zero (0). Alternatively, a different TV format may be used as illustrated in FIG. 12. The TV format seen in FIG. 12 is three (3) octets long and is used when the WTRU has only one PDN connection. Each bit position maps to the possible EPS bearer identities that exist as defined above in Table 1. Thus, bit positions one (1) to four (4) are reserved while the other bit positions may be used as defined in Table 1.

Similarly, the chosen JET indicates that the WTRU 210 has only one PDN connection. Therefore, the linked EPS context may be derived from the WTRU 210 context in MME 230 and no signaling is required. The bits of octets two (2) and three (3), except bits zero (0) to four (4), map to the bearer identities of the WTRU 210. Alternatively, if one (1) EPS bearer context exists, the specific EPS bearer context may be represented by including the proposed TEs in the NAS message.

In another embodiment, a representation format for EPS bearer contexts is defined. The formats may be used as TEs to refer to a specific bearer context in NAS ESM messages.

The formats to represent an EPS bearer context identity may include a combined linked EPS bearer identity value and an EPS bearer identity value (i.e., the EPS bearer context identity JET). The combined term represents the combination of the linked EPS bearer identity and the EPS bearer identity to represent the full EPS bearer context as shown in FIG. 13, which uses eight (8) bits. FIG. 14 represents a full EPS bearer context identity using four (4) bits for the EPS bearer identity context JET.

Alternatively, the linked EPS bearer identity and EPS bearer context identity may be specified separately. This is related to the EPS bearer identity described above. FIG. 15 and FIG. 16 show a representation of the linked EPS bearer identity.

In another embodiment, a format for the EPS bearer context status IE is described. The EPS bearer context status IE may include both the linked EPS bearer identity and the EPS bearer identity in order to uniquely identify an EPS bearer context. The format may be used to achieve the functionality with the distinction of having a different value for the JET to reflect an EPS bearer context status IE.

Alternatively, if one (1) EPS bearer context exists, then the specific EPS bearer context may be represented by including the proposed IEs with respect to the NAS message.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

What is claimed is:

1. A mobility management entity (MME) comprising:
a transceiver configured to receive a tracking area update (TAU) request message including an evolved packet system (EPS) update type information element;
a processor configured to verify a value of an active flag bit within the EPS update type information element; and
on a condition that the value of the active flag bit is equal to one, the processor is further configured to only maintain non-access stratum (NAS) signaling.

2. The MME as in claim 1 wherein on a condition that the value of the active flag bit is equal to one, the processor is further configured to maintain NAS signaling without establishing S1 bearer and radio bearer for all active EPS bearer context.

3. The MME as in claim 1 wherein the processor is further configured to activate radio bearer and S1 bearer on a condition that there is data to be transmitted, the value of the active flag bit is equal to one, and on a condition that there is an EPS bearer context for which the radio bearer and S1 bearer are to be established.

4. The MME as in claim 1 wherein on a condition that the NAS signaling is maintained and an EPS bearer context information element is not included in the TAU request message, radio bearer and S1 bearer are not established.

5. The MME as in claim 1 wherein the transceiver is further configured to transmit a TAU accept message.

6. A wireless/transmit receive unit (WTRU) comprising:
a processor configured to perform a tracking area update (TAU) procedure by setting a value for an active flag bit and setting a value for an evolved packet system (EPS) update type in an EPS update type information element; and
a transceiver configured to transmit a TAU request message including the value of the active flag bit and the value of the EPS update type in order to indicate whether to maintain NAS signaling, and whether a radio bearer and S1 bearer are to be established for all active EPS bearer context.

7. The WTRU as in claim 6 wherein the value of the active flag bit is set equal to one in order to maintain NAS signaling.

8. The WTRU as in claim 6 wherein on a condition that the value of the active flag bit is set equal to zero, the NAS signaling is not maintained.

9. The WTRU as in claim 6 wherein first three bits of the EPS update type information element represent an EPS update type value.

10. The WTRU as in claim 9 wherein the value of the EPS update type represents TAU by indicating maintaining of NAS signaling for a subsequent NAS signaling message.

11. The WTRU as in claim 6, further comprising:
a receiver configured to receive a TAU accept message.

12. The WTRU as in claim 6 wherein the processor is configured to define a format for an information element including a type and value format, which includes an EPS bearer context status information element.

13. The WTRU as in claim 6 wherein the processor is further configured to identify EPS bearer contexts in an EPS bearer context status information element.

14. The WTRU as in claim 6 wherein the transceiver is further configured to transmit an uplink NAS transport message.

15. A method comprising:
receiving a tracking area update (TAU) request message including an evolved packet system (EPS) update type information element;
verifying a value of an active flag bit within the EPS update type information element; and
on a condition that the value of the active flag bit is equal to one, only maintaining non-access stratum (NAS) signaling.

16. The method as in claim 15 wherein on a condition that the value of the active flag bit is equal to one, maintaining NAS signaling without establishing S1 bearer and radio bearer for all active EPS bearer context.

17. The method as in claim 15, further comprising:
activating radio bearer and S1 bearer on a condition that there is data to be transmitted, the value of the active flag bit is equal to one, and an EPS bearer context for which radio bearer and S1 bearer are to be established.
